(19) United States
(12) Patent Application Publication
(10) Pub. No.: US 2005/0247539 A1
(43) Pub. Date: Nov. 10, 2005

(54) Belt conveyor for agitator vehicles

(75) Inventors: Roinhold Kletsch, Bad Buchau (DE); Helmut Brauchle, Bad Schussenried (DE); Andreas Hueber, Leutkirch (DE)

Correspondence Address: ALLEMAN HALL MCCOY RUSSELL & TUTTLE LLP, 806 SW BROADWAY, SUITE 600, PORTLAND, OR, 97205-3335, US

(73) Assignee: Liebherr-Mischtechnik GmbH

(21) Appl. No.: 11/125,619

(22) Filed: May 9, 2005

(30) Foreign Application Priority Data
May 10, 2004 (DE) 10 2004 022 931.7

(51) Int. Cl. B65G 21/10

(52) U.S. Cl. 198/314

(57) ABSTRACT

The present disclosure relates to a belt conveyor for agitator vehicles consisting of a plurality of elements which are each connected to one another, pivotably to one another, by means of joints and which have driven transport belts for the transport of transport material such as concrete, sand, stone chippings or round gravel from the agitator vehicle to a pre-determined point, for example on a building site. In accordance with the present disclosure, the belt conveyor consists of four elements, of which the second and/or third element can be telescoped and the last element is not changeable in its length.

### CROSS-REFERENCE TO RELATED APPLICATION

This application claims priority to German Patent Application Serial No. DE 102004022931.7 filed May 10, 2004, which is hereby incorporated by reference in its entirety for all purposes.

### BACKGROUND AND SUMMARY

The present application relates to a belt conveyor for agitator vehicles.

Belt conveyors are used to deliver materials such as concrete, sand, stone chippings or round gravel from an agitator vehicle to the building site. The transport from the concrete factory to the building site should be processed fast and economically. This can be achieved by a commercial agitator vehicle that is fitted with a corresponding transport conveyor. The latter is capable of conveying the transport materials from the agitator vehicle to a specific spot on the building site. One example type of belt conveyor consist of three rigid elements linked to one another. The corresponding elements can be pivoted with respect to one another around the joint positions via piston cylinder arrangements. To allow these belt conveyors to be taken along with the agitator vehicle, the elements of the belt conveyor may be collapsed in a transport position such that they do not project beyond the outer contour of the vehicle in the front section, that is not beyond the driver's cabin. In the working position, they adopt a comparatively slightly inclined position so that the transport material can be transported over the conveyor belts.

It is also already known from FR-A-2450175 and EP-A-0424591 to make individual elements of the belt conveyor in telescopic form to improve the working radius of the belt conveyor in the working position.

A belt conveyor has become known from EP 0 654 427 B1 in which particularly the last element of the three elements forming the belt conveyor is telescopic, with a dispensing funnel or a dispensing slide being arranged at the last element. The advantage in this is seen in that, on a building site, the belt conveyor can also extend through a small window which is at a different height to the agitator vehicle, since the joint between the second and third elements can in particular be arranged in the region of the window opening. However, in this known embodiment, a comparatively large angle of 30° or more may be adopted, for example in the case of conveying the transport material into a building with a corresponding pivoting of the last element with respect to the second element of the belt conveyor. An abrupt transition is therefore formed from the inclined to the horizontal conveying of the transport material. With such a pronounced kink of the conveyor belt, unwanted separations may occur on the conveying of a transport material such as concrete. To prevent this, the conveying speed of the belt conveyor must be substantially reduced.

It is therefore the object of the present disclosure to further develop a generic belt conveyor such that the belt speed can be increased on the transport of the transport material without a separation of the material taking place at the kink point.

In one embodiment, this object may be solved by a belt conveyor for agitator vehicles comprising an assembly of at least four elements which are each pivotably connected to one another by joints and which have driven transport belts for the transport of transport material from the agitator vehicle to a predetermined point, the first element being pivotably supported around a vertical axis, the last element having a dispensing funnel or a dispensing slide, wherein at least one element can be telescoped and wherein the elements can be collapsed from a working position into a transport position, wherein the second or third element can be telescoped, and wherein the last element has a substantially fixed length.

Accordingly, a generic belt conveyor is assembled from four elements, of which the second and/or third element can be telescoped, while the last element has a substantially fixed length. Due to the provision of the four elements, two kink points can be provided in the end region of the belt conveyor which make a transition from the inclined conveying to the horizontal conveying of the transport material substantially more gentle. The belt speed can thereby be increased without any jumping over of material taking place at the kink point. An unwanted separation of concrete or of another transport material is reliably prevented. The rollers and transport belts are also spared in the region of the kink points formed here.

A further advantage of the present disclosure consists of the fact that, if desired, the maximum possible conveying height can be increased, since the last kink point is close to the end of the belt. If the second and third elements are made to be telescopic, both telescopes can be used for the maximum conveying height. Here, the comparatively short, fourth element, which is not telescopic, is admittedly kinked comparatively more pronouncedly. In this special case, in which a high conveying height is important, however, the conveying speed can be reduced to prevent the separation of the transport material.

A higher flexibility and a greater applicability can thus be realized by the belt conveyor in accordance with the present disclosure.

Further details, alternative embodiments, and other advantages of the present disclosure are described herein. For example, in the transport position, the first element is aligned vertically to the vehicle body, while the three following elements are aligned horizontally to the vehicle body. A version of the belt conveyor can thereby be realized which can be brought fast into the working position in comparison to EP 0 654 427 B1.

In another aspect of the present disclosure, the belt conveyor is received rotatably on a platform and that the platform can be coupled to or uncoupled from the vehicle body.

### BRIEF DESCRIPTION OF THE FIGURES

Further details and advantages of the present disclosure result from the example embodiments shown in the drawings.

FIG. 1 is a first embodiment of an agitator vehicle with a belt conveyor in a working position.

FIG. 2 is a detail of the conveyor in accordance with an alternative embodiment from FIG. 1.

FIG. 3 is a the agitator vehicle with the belt conveyor in accordance with FIG. 1 in two other positions.

FIG. 4 is a detailed representation of FIG. 3 in an enlarged representation.

### DETAILED DESCRIPTION

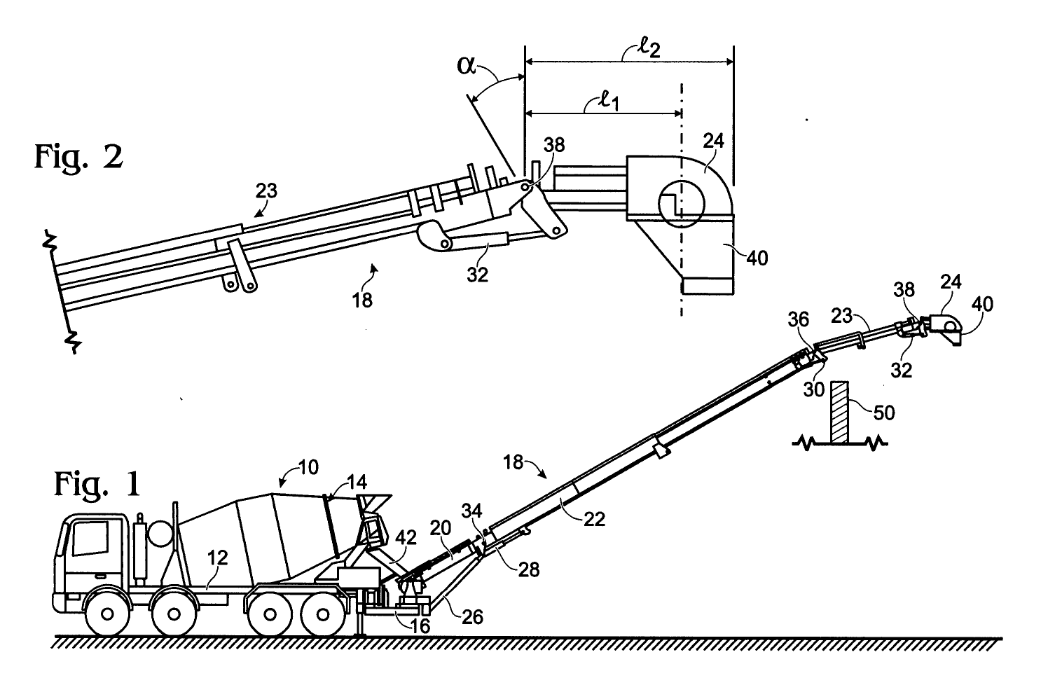

In FIG. 1, an agitator vehicle of conventional design is designed by 10 in which a mixing apparatus 14 with a mixing drum is mounted on a vehicle body 12. A platform 16, on which a belt conveyor 18 is vertically pivotably arranged, is coupled to the vehicle body 12. The pivot system is not shown in any more detail here. In the embodiment shown here, it consists of a ball-turning connection. The pivot drive permits a pivot range of 240°.

The belt conveyor substantially consists of four individual elements, namely the first element 20, the second element 22, the third element 23 and the last and fourth element 24. The individual elements are pivotable with respect to one another around pivot points 34, 36 and 38 via piston cylinder arrangements 26, 28, 30 and 32. The second element 22 and the third element 23 are each telescopic, as results from FIG. 1 in which these elements are shown in the position telescoped out. The second element 22 is a four meter long telescope in the embodiment shown, while the third element 23 is a one meter long telescope. The fourth element, which has a dispensing funnel 40 for the transport material, that is for example for the concrete, is comparatively short and is not adjustable in its length. Drivable transport belts are supported on the elements 20, 22, 23 and 24 of the transport conveyor 18 and the transport material can be conveyed via the elements from a dispensing slide 42 of the agitator vehicle 10 up to the dispensing funnel 40 at the end of the fourth element 24.

The transition from the inclined to the horizontal conveying can be made gentle in the end region of the transport conveyor 18 by the two pivot or kink points 36 and 38. An angle of around 15° is set at the kink points 36 and 38. Despite the high transport speed of the transport belts not shown in any more detail here, the transport material can hereby be conveyed fast with reduced separation of the transport material taking place on the transition from the transport belt of the element 22 to the transport belt of the element 23 or on the transition from the transport belt of the element 23 to the transport belt of the last element 24. In FIG. 1, a wall is shown by way of example at 50 beyond which the belt conveyor 18 conveys the transport material to a desired position on a building site.

In FIG. 2, the length relationships of the fourth element 24 of the belt conveyor 18 are shown. Here, the length L2 is between 1.150 meters and 2 meters, whereas the length L1 amounts to 0.85 meters for the case that the length L2 amounts to 1.150 meters. The third element 23 is telescoped out in the embodiment as is shown in FIG. 2. The transport belt, not shown in any more detail here, is held under tension on the retraction of the telescope via clamp apparatuses known in their design and also not shown in any more detail here. The same applies to the transport belt of the second element 22 which can be telescoped out.

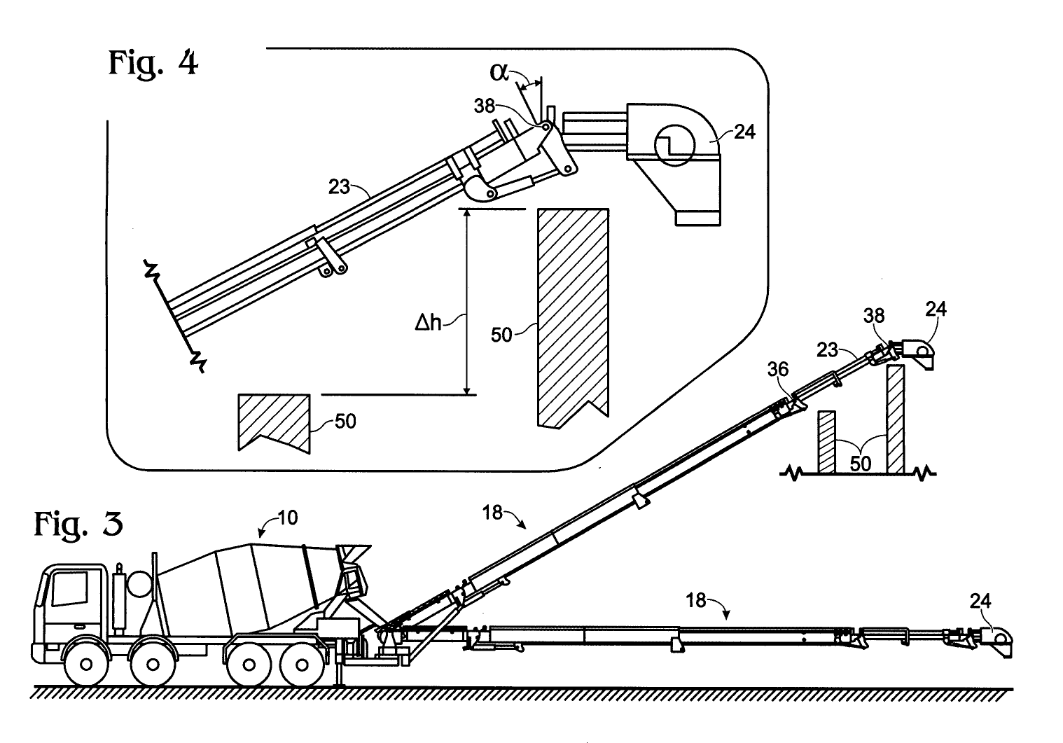

The angle α at the pivot point 36 amounts to approximately 15° in FIG. 2. Two different positions of the transport conveyor 18 are shown in FIG. 2. It becomes clear here that the maximum possible conveying height can be increased in comparison with known transport conveyors, since the last kink point 38 is close to the end of the transport belt. Both telescopic elements 22 and 23 are utilized for the maximum conveying height here. The compromise is accepted here that the angle α (in accordance with FIG. 4) is larger—in the embodiment shown here 30°. To avoid separation, a slower transport speed of the transport material is run here. In contrast, however, a vertical difference of Δh of more than one meter can additionally be overcome.

A very flexible application possibility for the belt conveyor hereby results.

1. A belt conveyor for agitator vehicles comprising a plurality of elements which are each connected to one another, pivotably to one another, by means of joints and which have driven transport belts for the transport of transport material from the agitator vehicle to a pre-determined point, wherein the first element is pivotably supported around a vertical axis, wherein the last element has a dispensing funnel or a dispensing slide, wherein at least one element can be telescoped and wherein the elements can be collapsed from a working position into a transport position, and wherein the belt conveyor is assembled from four elements, of which the second or third element can be telescoped; and in that the last element is not changeable in its length.

2. A belt conveyor for agitator vehicles in accordance with claim 1, wherein the first element in the direction of transport is aligned vertically to the vehicle body, while the three following elements are aligned horizontally to the vehicle body.

3. A belt conveyor for agitator vehicles in accordance with claim 1, wherein the belt conveyor is received rotatably on a platform and wherein the platform can be coupled to or uncoupled from the vehicle body.

4. A belt conveyor for agitator vehicles in accordance with claim 2, wherein the belt conveyor is received rotatably on a platform and wherein the platform can be coupled to or uncoupled from the vehicle body.

5. A belt conveyor for agitator vehicles in accordance with claim 1, wherein the transport material is at least one of concrete, sand, stone chippings and round gravel.

6. A belt conveyor for agitator vehicles in accordance with claim 1, wherein the pre-determined point is a building site.

7. A belt conveyor for agitator vehicles in accordance with claim 1, wherein the second and third element can be telescoped.

8. A belt conveyor for agitator vehicles comprising:
an assembly of at least four elements which are each pivotably connected to one another by joints and which have driven transport belts for the transport of transport material from the agitator vehicle to a pre-determined point, the first element being pivotably supported around a vertical axis, the last element having a dispensing funnel or a dispensing slide, wherein at least one element can be telescoped and wherein the elements can be collapsed from a working position into a transport position, wherein the second or third element can be telescoped, and wherein the last element has a substantially fixed length.

9. A belt conveyor for agitator vehicles in accordance with claim 8, wherein the second and third element can be telescoped.

10. A belt conveyor for agitator vehicles in accordance with claim 9, wherein the fourth element is comparatively shorter than the second and third elements.

11. A belt conveyor for agitator vehicles in accordance with claim 8, wherein the first element in the direction of transport is aligned vertically to the vehicle body, while the three following elements are aligned horizontally to the vehicle body.

12. A belt conveyor for agitator vehicles in accordance with claim 8, wherein the belt conveyor is received rotatably on a platform and wherein the platform can be coupled to or uncoupled from the vehicle body.

13. A belt conveyor for agitator vehicles in accordance with claim 12, wherein the transport material is at least one of concrete, sand, stone chippings and round gravel.

14. A belt conveyor for agitator vehicles in accordance with claim 13, wherein the pre-determined point is a building site.

15. A belt conveyor for agitator vehicles in accordance with claim 8, wherein the second and third element can be telescoped.

16. A belt conveyor for agitator vehicles comprising:
an assembly of at least four elements which are each pivotably connected to one another by joints and which have driven transport belts for the transport of transport material from the agitator vehicle to a pre-determined point, the assembly having an end region located near said pre-determined point, wherein at least two kink points are provided in said end region which make a transition from inclined conveying to horizontal conveying of the transport material.
